(19) United States
(12) Patent Application Publication
(10) Pub. No.: US 2020/0164779 A1
(43) Pub. Date: May 28, 2020

(54) FACE-TO-FACE CAR SEATS AND BED FORMED BETWEEN THEM

(71) Applicant: JetBed, Inc., San Diego, CA (US)

(72) Inventor: Gerald Bosstick, Rancho Santa Fe, CA (US)

(21) Appl. No.: 16/637,172

(22) PCT Filed: Aug. 7, 2018
(86) PCT No.: PCT/US18/45559

§ 371 Date: Feb. 6, 2020

Related U.S. Application Data
(60) Provisional application No. 62/541,955, filed on Aug. 7, 2017.

(51) Int. Cl. B60N 2/34

(52) U.S. Cl. CPC B60N 2/345; A47C 17/34

(57) ABSTRACT

The present invention includes a rotating driver or passenger seat adjacent to a front dash of a car, truck, van or similar automotive vehicle having a first set/row of car seats facing forward in the position where a driver and passenger would typically sit and a second row of car seats (or a bench type) immediately behind the backs of the first row of car seats. The driver and/or passenger as seat of the first row of car seats can be adapted to rotate substantially 180 degrees and optionally be moved apart from the second row of car seats, thereby providing face-to-face interaction between the occupants of front row car seat and an occupant of the second row of car seats. Further, the face-to-face car seats are transformed into a horizontal bed surface adapted to provide a user with a flat surface upon which a user may lie on their back, side or stomach.

### CROSS REFERENCE TO RELATED APPLICATIONS

This application claims the benefit of U.S. Provisional Application No. 62/541,955, filed Aug. 7, 2017, entitled FACE TO FACE CAR SEATS AND BED FORMED BETWEEN THEM. The entire content of the foregoing is hereby incorporated by reference herein.

### FIELD OF INVENTION

The present invention relates to bed structures having an inflatable and/or collapsible/deflatable component for use in cars configured to have facing seats.

### BACKGROUND OF THE INVENTION

The forward-facing orientation of car seats had remained substantially unchanged for as long as cars have been in production. However, a radical new technology has arrived that allows for more flexibility in the orientation of car seats.

Autonomous cars (also known as driverless or self-driving cars) have arrived (https: //en <dot>wikipedia <dot>org/wiki/Autonomous_car) and changed the occupation of the driver. An autonomous car is a vehicle that is capable of sensing its environment and navigating without human input. SAE International has established convenient classification of autonomy of cars available or to be made available: SAE automated vehicle classifications include different levels of autonomy, as follows:

Level 0: Automated system issues warnings but has no vehicle control.

Level 1 (“hands on”): Driver and automated system shares control over the vehicle. An example would be Adaptive Cruise Control (ACC) where the driver controls steering and the automated system controls speed. Using Parking Assistance, steering is automated while speed is manual. The driver must be ready to retake full control at any time. Lane Keeping Assistance (LKA) Type II is a further example of level 1 self-driving.

Level 2 (“hands off”): The automated system takes full control of the vehicle (accelerating, braking, and steering). The driver must monitor the driving and be prepared to immediately intervene at any time if the automated system fails to respond properly. The shorthand “hands off” is not meant to be taken literally. In fact, contact between hand and wheel is often mandatory during SAE 2 driving, to confirm that the driver is ready to intervene.

Level 3 (“eyes off”): The driver can safely turn their attention away from the driving tasks, e.g. the driver can text or watch a movie. The vehicle will handle situations that call for an immediate response, like emergency braking. The driver must still be prepared to intervene within some limited time, specified by the manufacturer, when called upon by the vehicle to do so.

Level 4 (“mind off”): As level 3, but no driver attention is ever required for safety, i.e. the driver may safely go to sleep or leave the driver's seat. Self-driving is supported only in limited areas (geofenced) or under special circumstances, like traffic jams. Outside of these areas or circumstances, the vehicle must be able to safely abort the trip, i.e. park the car, if the driver does not retake control.

Level 5 (“wheel optional”): No human intervention is required. An example would be a robotic taxi.

In Level 3, 4, and 5 cars, it can be possible for the conventional forward-facing orientation of car seats to be changed temporarily or at all times to the benefit of the car occupants.

### SUMMARY OF THE INVENTION

The present invention in a first embodiment includes a rotating driver or passenger seat adjacent to a front dash of a car, truck, van or similar automotive vehicle having a first set/row of car seats facing forward in the position where a driver and passenger would typically sit and a second row of car seats (or a bench type) immediately behind the backs of the first row of car seats. In embodiments of the invention, the driver and/or passenger seat of the first row of car seats can be adapted to rotate substantially 180 degrees and optionally be moved apart from the second row of car seats, thereby providing face-to-face interaction between the occupants of front row car seat and an occupant of the second row of car seats.

Embodiments of the invention include a method of operating the vehicle under SAE Level 3 to Level 5 operation of the vehicle, allowing a driver to temporarily or at all times remain rotated in a backward direction without interaction with the vehicle, but permitted to face rearward and engage in interactions with occupants of the second row of car seats. The orientation of the car seats forms a face-to-face arrangement with a substantial space between them to allow for the legs of the seats to be comfortably located.

In a second embodiment of the invention, the face-to-face car seats are transformed into a horizontal bed surface adapted to provide a user with a flat surface upon which a user may lie on their back, side or stomach. A collapsible foundation block is adapted to perform a space filling function as to a space between two face-to-face seats that are secured to a floor structure forming a horizontal surface. The foundation block is preferably inflatable and is supported from a floor surface between the two face-to-face seats, whereafter a supporting structure of the foundation block rises to a top surface generally parallel to the floor. The elevation of the top surface is approximately a level of a top surface of seat cushions of the two facing seats.

In one simple form, a bed surface is formed by placement of the foundation block in a space between two face-to-face seats. The bed surface is formed by, starting at a head portion, a top surface of a seat cushion of a first seat, the top surface of the foundation block, and a top surface of a seat cushion of a second seat, where the first and second seats face each other and are separated by a space of about two to four feet.

In a more advanced form, the foundation block is fixed in place relative to the floor and the seats, preventing the foundation block from shifting and perhaps becoming dislodged when a user lies on it.

Also in a further advanced form, a top surface of the bed is provided such that a user will not perceive any breaks in continuity, material, or cushioning between the top surfaces of the seats and the top surface of the foundation block. By avoiding perception of breaks and surface changes, ultimately it is possible to avoid discomfort over a long period of rest upon them.

Still further in an advanced form, the top surface is shaped, or extra portions are provided, such that seat declination of the seat cushions are not perceived, providing a substantially flat conformation throughout the entire area of the top surface, thus avoiding a user's head from being angled downward from the neck. Given the fact that typical car seats have a front, elevated edge of the seat cushion, the declination can be so severe that a user can find it difficult to tolerate such a position for a long duration of rest. In some embodiments, a small pillow can be inserted into the rear portion of the seat cushion, tending to provide a generally more level overall top surface for a user's head. In some embodiments, the pillow can be shaped such that it does not introduce yet another discontinuity in the overall resting surface.

A comfortable bed surface is expected by a user to constitute a generally flat surface from head to feet which is horizontal relative to a floor.

In some advanced forms of the bed device, the discontinuities and seat declinations arising from use of other forms of the invention can be eliminated. A top pad, preferably enclosed in a soft but durable fabric envelope, is attached to the entire top surface of the foundation block, forming a relatively planar first bed surface parallel to the floor. Adjacent edges of the top pad lie substantially adjacent to an upper elevation of the seat cushions of each seat, i.e., at a front edge of the seat cushion. Connected by hinges or flexible hinge-like attachment to the adjacent edges are connection edges of filler pads. Filler pads are adapted to lie on the top surface of a declination type seat and substantially conform, on a underside, to the declination curvature. A second bed surface of the filler pads is a flat topside and substantially co-planar with the first bed surface. In some embodiments, the entire bed surface upon which a user may lie on their back, side or stomach consists of a first bed surface of the top pad and two second bed surfaces of the filler pads adjacent to and substantially co-planar with the top pad. The flexible or hinge connection between the top pad and the filler pads eliminates sensed discontinuities in the entire bed surface.

Objects of the second embodiment of the invention are:

1. to provide an inflatable foundation block capable of filling a space between two spaced apart, facing chairs as in the first embodiment of the invention, to form a relatively flat surface, including the seat surfaces of the chairs, to form a bed surface;

2. to provide a pair of filler pads flexibly attached to top end edges of the foundation block that, when the foundation block is in inflated and in place, extend onto the seat surfaces to provide a more uniform bed surface from one end an entire bed surface to the other;

3. to provide securing flanges or lateral extensions that extend from a lateral edge of the filler pads and down against a right or left side of a seat to reduce side to side movement of the entire assembly when in place;

4. to provide a fabric covered, foam top cushion for the foundation block top surface that is effectively continuous with the tops of the two filler pads so that a user experiences a uniform softness of the bed surface from one end to the other; and

5. to provide all of the features and benefits of objects 1-5 in a form that is constructed to be durable yet inexpensive enough to be a viable accessory for use in many automobiles.

A user can lie down securely for long periods of time on the bed surface. The foundation block can be deflated and other extensions from it folded into a small volume for compact storage. Safety belts are preferably used to secure someone to the bed surface sufficient for meeting requirements for passenger safety.

Embodiments of the invention relate to a method of installing a bed in an automotive vehicle. The method can include providing an automotive vehicle having a floor and a plurality of seats fastened to the floor, wherein at least two seats can each include a backrest, a sitting surface, and a support frame, wherein the sitting surface can include a front edge and wherein the sitting surface can tilt downward from the front edge to a rear portion of the sitting surface proximate the backrest, the front edge having a first elevation above the floor and the rear portion having a second elevation above the floor, wherein the first elevation is greater than the second elevation, and wherein the at least two seats can be oriented such that a first seat is in front of a second seat, and further wherein the first seat can be configured to alternate between a forward-facing orientation and a rearward-facing orientation. The method can include placing the first seat into the rearward-facing orientation, such that the first seat is facing the second seat, with an open space therebetween. The method can include placing, in the open space, a foundation block having a top surface, a bottom surface, two end walls and two side walls, wherein the bottom surface is supported by the floor between the two seats, the end walls and side walls rise to support the top surface at about the first elevation, the top surface having a width about that of the sitting surface of the seats, the top surface having a length from a top of one end wall to a top of another end wall which equals about a distance between opposing front edges of the sitting surfaces of the first and second seats, and wherein the entire foundation block can be adapted to be collapsed in a stowage state and expanded in an installed state so that it can be capable of supporting on the top surface at about the first elevation a weight of a user.

In some embodiments, the method can include placing or deploying a sleeping pad comprising a top sleeping surface, the sleeping pad and sleeping surface having a length capable of extending from the backrest of the first seat to the backrest of the second seat.

In some embodiments, the sleeping pad can include a substantially uniform thickness and is affixed to the top surface of the foundation block.

In some embodiments, the sleeping pad can further include at least two filler pads fixed to the sleeping pad, each filler pad having a shape and size that is substantially complementary to the slope from the front edge of each sitting surface rear portion of each sitting surface, such that the filler pad supplies a support to the sleeping surface permitting the sleeping surface to be substantially horizontal throughout its area.

In some embodiments, the sleeping pad and filler pads can be enclosed in a flexible fabric envelope and can be rotatably connected by an integral fabric section.

In some embodiments, each filler pad can have a width about equal to the sitting surface width and a length about equal to a distance from the front edge to the rear portion.

In some embodiments, the filler pads can be adapted to be rotated upward and around their rotatable connection to the sleeping pad so that each filler pad lies on a top of the sleeping surface in the stowage state.

Some embodiments of the invention relate to a device having the structural features described above.

### BRIEF DESCRIPTION OF THE DRAWINGS

FIG. 1 is a perspective view of a conventional forward-facing car seat.

FIG. 2 is a side and cutaway view of two forward-facing car seats fixed to a vehicle floor, defining a space between them and showing a steering wheel for a driver to interact with control of the vehicle.

FIG. 3 is a side and cutaway view of two conventional, forward-facing car seats fixed to an autonomous vehicle floor, defining a space between them and without a steering wheel for a driver to interact with control of the vehicle.

FIG. 4 is a side and cutaway view of two car seats fixed to an autonomous vehicle floor, similar to those of FIG. 3, but with a driver's seat rotated 180 degrees rearward and moved apart from a second row of car seats.

FIGS. 5, 6 and 7 are, respectively, top, side and bottom views of one embodiment of a foundation block with a top pad fixed to its top surface and two filler pads rotatably connected with the assembly of the foundation block and top pad.

FIG. 8 is the seats of FIG. 4 with a cross section view of the device of FIG. 5 showing a substantially planar bed surface capable of comfortably supporting a user in a lying down position.

FIG. 9 is a side cross section view of one embodiment of the foundation block having a flexible fabric exterior and a material filled interior.

FIG. 10 is a side view of an inflatable foundation block.

FIG. 11 is a side cross section view of the foundation block of FIG. 10.

FIGS. 12, 13 and 14 are, respectively, top, side and end views of a preferred embodiment of the foundation block.

FIG. 15 is a partial view of section 61 of FIG. 13.

FIG. 16 is the view of FIG. 15 with the addition of a fabric covered top pad.

FIG. 17 shows the view of FIG. 8 with a reclining human shape on the bed surface.

FIG. 18 shows the view of FIG. 8 with two filler pads rotating about their connections to the top pad.

FIG. 19 shows the view of FIG. 8 with the two filler pads rotated so that their top surfaces lie upon a top of the top pad and the foundation block is deflated, providing a small volume storage size for the invention device.

### DETAILED DESCRIPTION OF THE INVENTION

The invention is now discussed with reference to the figures.

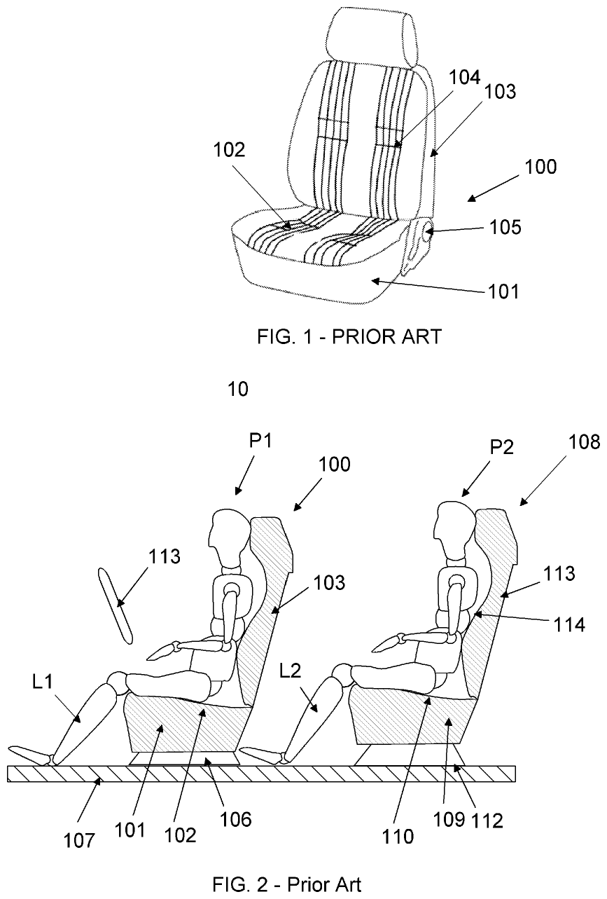

FIG. 1 shows a conventional, forward-facing car seat 100 comprising a bottom section 101 and having a top surface 102. A reclining or vertical back section 103 has a front surface 104, where section 101 and 103 connect by way of what is typically a pivoting connection 105. That form factor of a car seat has been known for decades, as well as the arrangement of car seats shown in FIG. 2, where seat 100 is fixed so that a person P1 may reach the steering wheel 113 with their arms and the floor controls with their legs L1. A first base 106 connects seat 100 to floor 107. Similarly, car seat 108 includes a bottom section 109 and having a top surface 110. A reclining or vertical back section 114 has a front surface 114, where section 109 and 113 connect by way of what is typically a pivoting connection.

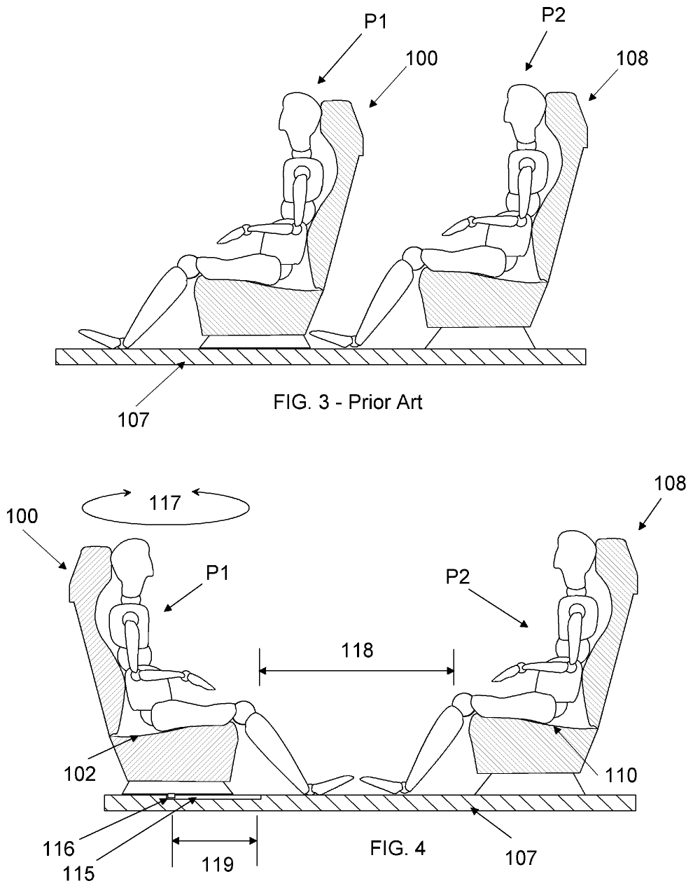

FIG. 3 is a side and cutaway view of to two conventional, forward-facing car seats 100 and 108 fixed to an autonomous vehicle floor 107, defining a space between them and without a steering wheel for a driver to interact with control of the vehicle.

FIG. 4 is a side and cutaway view of to two car seats 100 and 108 fixed to an autonomous vehicle floor 107, similar to those of FIG. 3, but with a driver's seat 100 rotated 180 degrees rearward about path 117 and moved apart from a second row of car seats with car seat 108 by distance 119 by moving pivot pin 116 in track 115 to provide a total separation distance between seats 100 and 108 of distance 118 so the legs of persons P1 and P2 do not touch or interfere with each other. The arrangement 10 of seats 100 and 108 allows for face-to-face interaction between person P1 and person P2 while the autonomous vehicle drives itself.

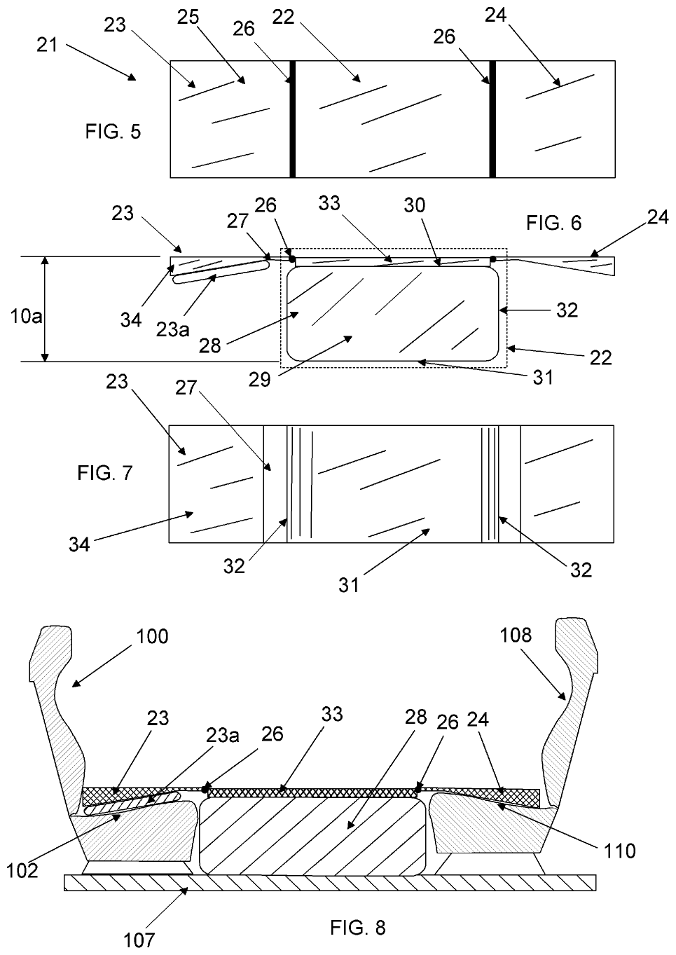

FIGS. 5, 6 and 7 are, respectively, top, side and bottom views of one embodiment 21 of center section 22 comprising a foundation block 28 and a top pad 33 attached to cover a top surface 30 of the foundation block 28. Foundation block 28 includes a top surface 30, a bottom surface 31, end walls 32 and side walls 29. Filler pads 23 and 24 are connected by a rotatable connection 26 to a top edge zone of center section 22, where filler pads 23 and 24 are rotatable about an axis formed by connection 26. Connection 26 preferably includes a connection of fabric covering filler pads 23 and 24 to fabric covering top pad 33. Filler pads 23 and 24 each include a thickened back section 34 and a thinner front edge section 27. Filler pads 23 and 24 are about a width of seat cushions upon which they will be supported. Top pad 33 is about the width of the filler pads 23 and 24. Elevation 10a is a height from the bottom surface 31 of foundation block 28 to a substantially co-planar set of three top surfaces, i.e., a top surface of top pad 33 and top surfaces of filler pads 23 and 24. Elevation 10a is equal to or greater than the elevation of the top surfaces of the bottom sections of seats 100 and 108 from the top of floor 107.

FIG. 6 includes an optional inflatable pad 34a to be fixed to the underside of filler pad 23 so that if a top surface of seat 100 is lower than that of seat 108, or vice versa, it can be inflated so the tops of filler pads 23 and 24 are essentially at the same elevation and within the same plane as pad 33.

FIG. 8 shows the seats 100 and 108 of FIG. 4 with a cross section view of the embodiment 21 of FIG. 6 showing a substantially planar bed surface capable of comfortably supporting a user in a lying down position. Bottom surface 31 of foundation block 28 is supported on floor 15 between seats 100 and 108. End walls 32 preferably contact or about the front surfaces of the upper sections of seats 100 and 108, providing resistance to movement of the foundation block 28 in the direction of the seats 100 and 108. Filler pads 23 and 24 have undersides generally conforming to and supported by a top surface or surfaces of the bottom sections of seats 100 and 108. It is apparent from inspection of FIG. 8 that a bed surface comprising a substantially co-planar set of three top surfaces, i.e., a top surface of top pad 33 and top surfaces of filler pads 23 and 24, is fully supported from floor 15 and seat cushions 12. The foundation block 28 is adapted to support hundreds of pounds of weight of a human torso with relatively little depression on top surface 30 when a user reclines on the bed surface. Therefore, a user's head (supported on one filler pad) is maintained at about the same level as a user's torso and thighs (supported by the top pad 33 and foundation block 28) and legs and feet (supported by the other filler pad). Forming foundation block 28 as an inflatable air mattress with internal structure baffles provides sufficient structural strength to accomplish the objects of the invention.

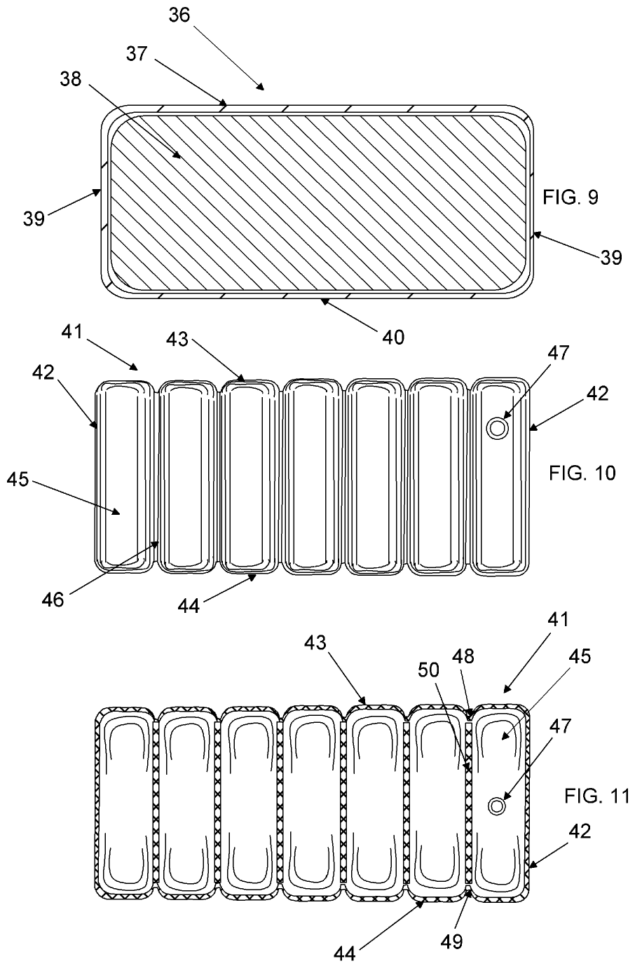

FIG. 9 is a side cross section view of one embodiment of the foundation block 36 having a flexible fabric exterior with sides 37, 39 and 40 and a material 38 filled interior. Material 38 can be or include a memory elastomer foam block or similar structure to accomplish the objects of the invention.

FIG. 10 is a side view of an inflatable foundation block 41 with end walls 42, top surface 43, bottom surface 44, and side walls 45 with a removable cap 47 which allows for inflation and deflation of block 41. FIG. 11 shows baffles 46 extending to connect top surface 43 at connection 48, side walls 45 at connection 50 and bottom surface 44 at connection 49 to form an inflated structure capable of supporting hundreds of pounds of weight of a human user of the invention devices.

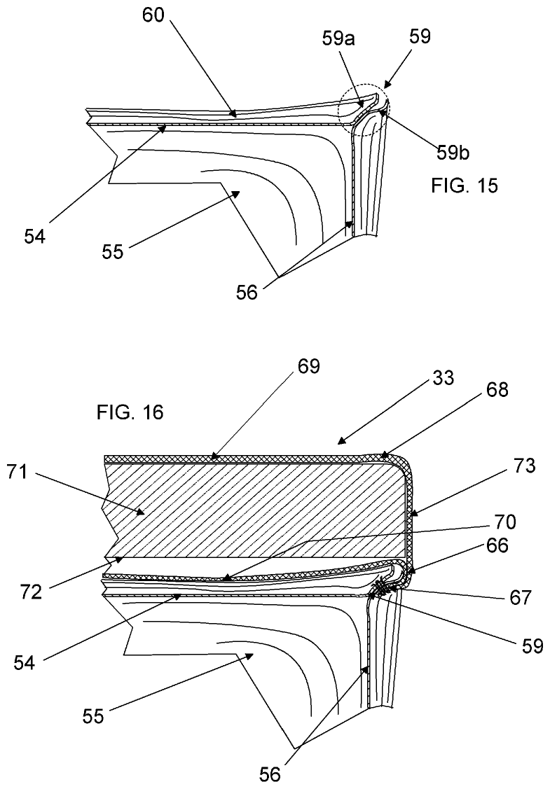

FIGS. 12, 13 and 14 are, respectively, top, side and end views of a preferred embodiment of the foundation block 53. Block 53 is generally rectangular and is formed of four sheets of flexible polymer material adapted to be used in air mattresses, such as polyvinyl chloride, or the like, where each sheet is joined by thermal or radio wave welding to another sheet along an edge. Block 53 includes a top surface 54, end walls 55, bottom surface 62 and side walls 56, whose flexible sheets joined at their edges result in excess layers 59, 60, 64, and 63. More or less layers can be employed. Baffles 58 separate the internal space of block 53 into seven structural sections 57. More or less structural sections can be employed.

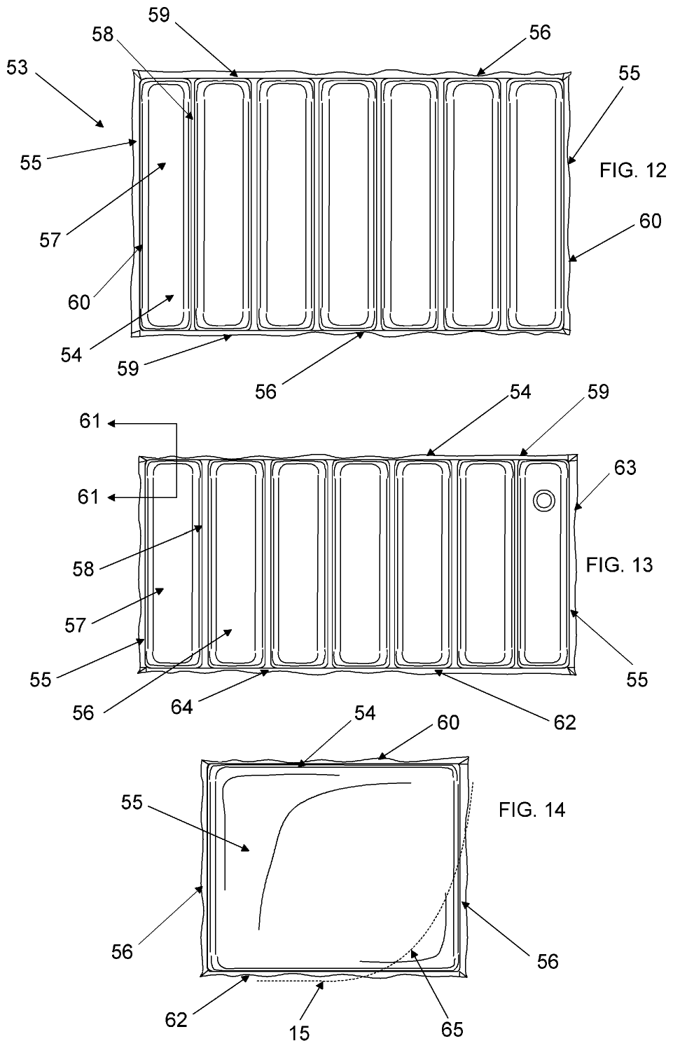

FIG. 15 is a partial view of section 61 of FIG. 13, where excess layer 59 is shown formed of joined sheets of top surface 54 and side wall 56 at sections 59a and 59b.

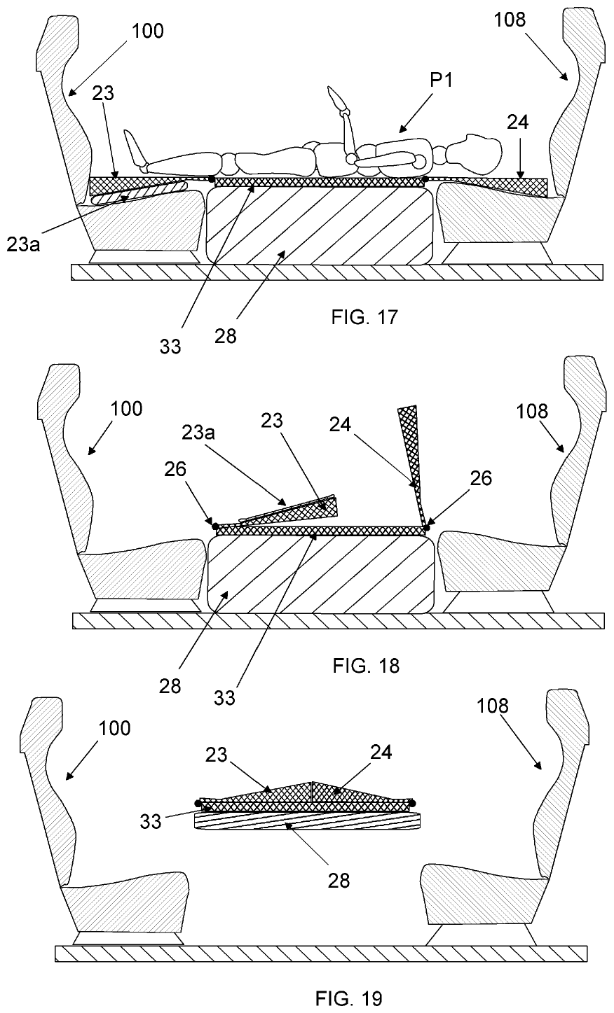

FIG. 17 shows the view of FIG. 8 with a reclining human shape on the bed surface, with a head and shoulders portion supported on filler pad 24, a torso and thighs section supported on top pad 33, and a legs and feet portion supported on filler pad 23. From this position, a user may lie comfortably on their side or stomach.

FIGS. 18 and 19 show collapsing and storage steps for the device of FIG. 17. FIG. 18 shows that pads 23 and 24 fold upward and over toward top pad 33 by connections 26. FIG. 19 shows foundation block 28 deflated into a compressed position and pads 23 and 24 folded on top of top pad 33 so that the entire device is stowable into small space.

The above design options will sometimes present the skilled designer with considerable and wide ranges from which to choose appropriate apparatus and method modifications for the above examples. However, the objects of the present invention will still be obtained by that skilled designer applying such design options in an appropriate manner.

What is claimed is:

1. A method of installing a bed in an automotive vehicle, comprising providing an automotive vehicle having a floor and a plurality of seats fastened to the floor, wherein at least two seats each comprise a backrest, a sitting surface, and a support frame, wherein the sitting surface comprises a front edge and wherein the sitting surface tilts downward from the front edge to a rear portion of the sitting surface proximate the backrest, the front edge having a first elevation above the floor and the rear portion having a second elevation above the floor, wherein the first elevation is greater than the second elevation, and wherein the at least two seats are oriented such that a first seat is in front of a second seat, and further wherein the first seat is configured to alternate between a forward-facing orientation and a rearward-facing orientation;
placing the first seat into the rearward-facing orientation, such that the first seat is facing the second seat, with an open space therebetween;
placing, in the open space, a foundation block having a top surface, a bottom surface, two end walls and two side walls, wherein the bottom surface is supported by the floor between the two seats, the end walls and side walls rise to support the top surface at about the first elevation, the top surface having a width about that of the sitting surface of the seats, the top surface having a length from a top of one end wall to a top of another end wall which equals about a distance between opposing front edges of the sitting surfaces of the first and second seats, and wherein the entire foundation block is adapted to be collapsed in a stowage state and expanded in an installed state so that is capable of supporting on the top surface at about the first elevation a weight of a user.

2. The method of claim 1, further comprising: placing or deploying a sleeping pad comprising a top sleeping surface, the sleeping pad and sleeping surface having a length capable of extending from the backrest of the first seat to the backrest of the second seat.

3. The method of claim 2, wherein the sleeping pad comprises a substantially uniform thickness and is affixed to the top surface of the foundation block.

4. The method of claim 2, wherein the sleeping pad further comprises at least two filler pads fixed to the sleeping pad, each filler pad having a shape and size that is substantially complementary to the slope from the front edge of each sitting surface rear portion of each sitting surface, such that the filler pad supplies a support to the sleeping surface permitting the sleeping surface to be substantially horizontal throughout its area.

5. The method of claim 4, wherein the sleeping pad and filler pads are enclosed in a flexible fabric envelope and are rotatably connected by an integral fabric section.

6. The method of claim 4, wherein each filler pad has a width about equal to the sitting surface width and has a length about equal to a distance from the front edge to the rear portion.

7. The method of claim 5, wherein the filler pads are adapted to be rotated upward and around their rotatable connection to the sleeping pad so that each filler pad lies on a top of the sleeping surface in the stowage state.

8. A device having the structural features recited in claim 1.
